(19) United States
(12) Patent Application Publication
(10) Pub. No.: US 2008/0268326 A1
(43) Pub. Date: Oct. 30, 2008

(54) CATALYST LAYER, MEMBRANE ELECTRODE ASSEMBLY, FUEL CELL HAVING MEMBRANE ELECTRODE ASSEMBLY, METHOD OF PRODUCING CATALYST LAYER, AND METHOD OF PRODUCING MEMBRANE ELECTRODE ASSEMBLY

(75) Inventors: Hiroshi Okura, Hiratsuka-shi (JP); Yoshinobu Okumura, Machida-shi (JP); Masaaki Shibata, Tokyo (JP); Mamiko Kumagai, Tokyo (JP); Kenji Nomiya, Machida-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/099,488

(22) Filed: Apr. 8, 2008

(30) Foreign Application Priority Data
Apr. 27, 2007 (JP) 2007-120002

(51) Int. Cl. H01M 4/86; C08G 63/00; C08G 77/12; B32B 9/00

(52) U.S. Cl. 429/40; 528/360; 528/31; 428/704

(57) ABSTRACT

There are provided a catalyst layer that improves power generation efficiency, a membrane electrode assembly, a fuel cell using the membrane electrode assembly, and a method of producing the membrane electrode assembly. Specifically, there are provided a catalyst layer including at least a first catalyst material and a second catalyst material which is different from the first catalyst material, in which the first catalyst material includes a polyacid having a thiol group, and the first catalyst material and the second catalyst material are bound to each other through a thiol bond; a membrane electrode assembly having the catalyst layer; a fuel cell having the membrane electrode assembly; a method of producing the catalyst layer; and a method of producing the membrane electrode assembly.

### BACKGROUND OF THE INVENTION

1. Field of the Invention

The present invention relates to a catalyst layer, a membrane electrode assembly, a fuel cell, a method of producing the catalyst layer and a method of producing the membrane electrode assembly.

2. Description of the Related Art

In general, as a material for constituting a catalyst layer of a polymer electrolyte fuel cell, platinum fine particles having a low activation overpotential are used as a catalyst for promoting a hydrogen oxidation reaction and an oxygen reduction reaction in many cases. However, platinum is expensive. Thus, in order to reduce the amount of platinum used and to improve the performance, there has been reported a method which employs a technology using a promoter (or co-catalyst). As an example of effectively using such a promoter, there is disclosed an example in which a polyacid is introduced in a catalyst layer (Japanese Patent Application Laid-Open No. 2002-134122).

However, in the case of forming the catalyst layer of a polymer fuel cell according to the method described in Japanese Patent Application Laid-Open No. 2002-134122, the polyacid in the catalyst layer and another material (specifically, platinum-carrying carbon) for constituting the catalyst layer are not bound to each other. Therefore, the method poses a problem that the polyacid is likely to be eluted by generated water. In the method described in Japanese Patent Application Laid-Open No. 2002-134122, the utilization efficiency of the polyacid is considered as problematic because the polyacid and other materials are dispersed in an electrolyte, and thus the polyacid irregularly exist not only near the catalyst which functions as a promoter but also throughout the catalyst layer. Therefore, the development of a membrane electrode assembly for a fuel cell which maintains advantageous respects of a conventional polymer fuel cell and also maintains advantageous respects of the polyacid has been strongly desired.

### SUMMARY OF THE INVENTION

The present invention has been accomplished in view of the above-mentioned background. According to the present invention, by binding a polyacid as a first catalyst material for constituting a catalyst layer to a second catalyst material as another material for constituting the catalyst layer, the polyacid can be fixed at a desired position, so that a catalyst layer having a high power generation efficiency, a membrane electrode assembly, a method of producing the catalyst layer and the membrane electrode assembly, and a fuel cell using the catalyst layer and the membrane electrode assembly can be provided.

According to a first aspect of the present invention, there is provided a catalyst layer which includes at least a first catalyst material and a second catalyst material which is different from the first catalyst material, in which the first catalyst material includes a polyacid having a thiol group and in which the first catalyst material and the second catalyst material are bound to each other through a thiol bond.

According to a second aspect of the present invention, there is provided a membrane electrode assembly which includes at least a catalyst layer and a polymer electrolyte membrane, in which the catalyst layer includes at least a first catalyst material and a second catalyst material which is different from the first catalyst material, the first catalyst material includes a polyacid having a thiol group, and the first catalyst material and the second catalyst material are bound to each other through a thiol bond.

The second catalyst material is preferably formed of platinum.

The polyacid preferably includes an organosilyl group.

Further, the fuel cell of the present invention includes the above-mentioned membrane electrode assembly.

According to a third aspect of the present invention, there is provided a method of producing a catalyst layer which includes mixing a first catalyst material including a polyacid having a thiol group and a second catalyst material which is different from the first catalyst material to form a mixture, thereby binding the first catalyst material and the second catalyst material through a thiol bond.

According to a fourth aspect of the present invention, there is provided a method of producing a membrane electrode assembly which includes at least a polymer electrolyte membrane and a catalyst layer including a first catalyst material and a second catalyst material. The method includes: mixing a first catalyst material including a polyacid having a thiol group and a second catalyst material which is different from the first catalyst material to form a mixture, thereby binding the first catalyst material and the second catalyst material through a thiol bond; and disposing the mixture on a surface of a polymer electrolyte membrane.

The mixture of the first catalyst material and the second catalyst material preferably contains a polymer electrolyte.

Further features of the present invention will become apparent from the following description of exemplary embodiments with reference to the attached drawings.

### BRIEF DESCRIPTION OF THE DRAWINGS

FIGS. 1A and 1B are schematic views each illustrating an example of a structure of a membrane electrode assembly of the present invention.

FIG. 2 is a structural view illustrating an example of a polyacid having thiol groups.

FIG. 3 is a graphical representation illustrating measurement results of current-potential characteristics of Example 1 of the present invention and Comparative Example 1.

FIG. 4 is a graphical representation illustrating measurement results of catalytic activities of Example 2 of the present invention and Comparative Example 2.

FIG. 5 is a general schematic view illustrating a fuel cell.

FIG. 6 is a graphical representation illustrating measurement results of current-potential characteristics of Example 3 of the present invention and Comparative Example 3.

### DESCRIPTION OF THE EMBODIMENTS

The present invention provides a catalyst layer that includes at least a first catalyst material and a second catalyst material which is different from the first catalyst material. In the catalyst layer, the first catalyst material includes a polyacid having thiol group(s), and the first catalyst material and the second catalyst material are bound to each other through thiol bond(s) (or thiol bonding).

Hereinafter, the present invention will be described in detail with reference to the attached drawings.

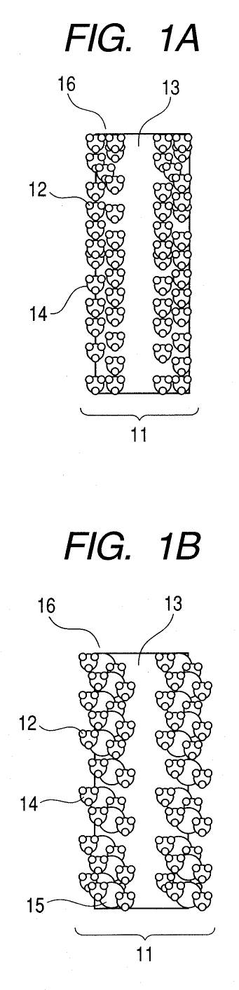

FIGS. 1A and 1B are schematic views each illustrating an example of the structure of a catalyst layer and a membrane electrode assembly of the present invention. FIGS. 1A and 1B illustrate a catalyst layer 16 formed of a first catalyst material 12 and a second catalyst material 14, and a membrane electrode assembly 11 formed of two catalyst layers 16 and a polymer electrolyte membrane 13.

Here, the first catalyst material is a polyacid having a thiol group and the second catalyst material is formed of a material different from the first catalyst material. The first catalyst material and the second catalyst material are bound to each other via the sulfur atom of the thiol group of the first catalyst material. Such a structure allows the polyacid as the first catalyst material to be firmly fixed to the second catalyst material.

The catalyst layer does not need to contain only the first catalyst material 12 and the second catalyst material 14, and may contain another material. For example, as illustrated in FIG. 1B, a carrier 15 for carrying the second catalyst material may be contained.

Hereinafter, the catalyst layer, the membrane electrode assembly, and the polymer electrolyte membrane which is a part of the membrane electrode assembly will be described in detail.

(Catalyst Layer)

The catalyst layer contains at least a first catalyst material and a second catalyst material.

(First Catalyst Material (Polyacid))

The first catalyst material is a compound which includes a polyacid having a thiol group (—SH group).

The term “polyacid” herein employed generally refers to an anion species obtained by condensation of polyhedrons called oxo acids, such as tetrahedrons, quadrangular pyramids, or octahedrons, which are formed by coordination of 4 to 6 oxide ions to an ion of a transition metal such as vanadium, molybdenum, or tungsten. The polyacid is represented by the chemical formula [MₓO_{y}]ⁿ⁻ (where M represents a transition metal, and x, y, and n each represent an arbitrary positive integer), and may sometimes be referred to as polyoxometallate (POM) or metal oxo acid. Further, a polyacid which is composed solely of a transition metal and oxygen is referred to as an isopolyacid and a compound further containing a heteroatom is referred to as a heteropolyacid. Of the polyacid, the basic skeletons which are frequently employed in the art are structural members typified by [PW₁₂O₄₀]³⁻ called Keggin structure or [P₂W₁₈O₆₂]ⁿ⁻ called Dawson structure.

The polyacid can take a variety of structures by possible combinations of transition metal elements, disposition of oxo acids, types of heteroatoms, deficient species in which oxo acids are deficient at several points, etc., as described above.

On the other hand, the term “polyacid” herein employed refers to a compound having a polyacid skeleton. More specifically, the term “polyacid” also encompasses a compound in which another molecule is bound to the anion species. Therefore, the “polyacid having a thiol group” in the present invention may be a compound in which a thiol group is bound to an anion species or may be a compound in which a molecule containing a thiol group is bound to an anion species.

The polyacid having a thiol group is represented by the following Chemical Formula (I):

A-S—H (1)

wherein A represents a portion other than the thiol group of the polyacid, S represents a sulfur atom of the thiol group of the polyacid, and H represents a hydrogen atom of the thiol group of the polyacid.

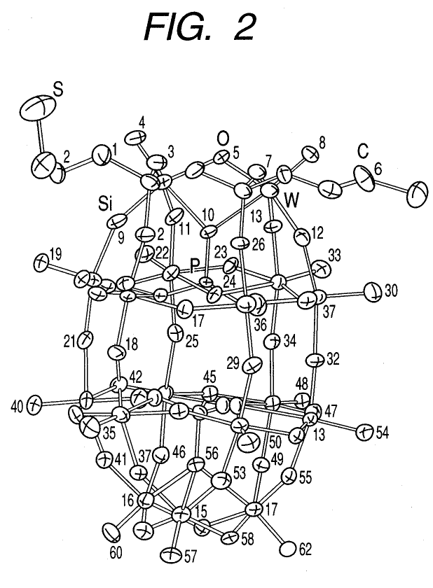

Mentioned as a specific example of such a polyacid having a thiol group is a thiol derivative of a polyacid to which an organosilyl group is introduced, which is described in, for example, Chem. Eur. J., No. 10 (2004), page 5517. The structural formula of a thiol derivative of the polyacid represented by ((CH₃)₂NH₂)5H[α₂-P₂W₁₇O₆₁{(HS(CH₂)₃Si)₂O}].6H₂O is illustrated in FIG. 2. Such a polyacid can be synthesized by changing the length of a carbon chain, and can preferably be used for the catalyst layer and the membrane electrode assembly of the present invention also from the viewpoint of the stability of the polyacid itself. Any polyacids having a thiol group can be used, and the polyacid is not limited to the above.

The first catalyst material is bound to the second catalyst material by the thiol group of the polyacid constituting the first catalyst material. The polyacid generally functions as a catalyst. For example, the polyacid has a function of separating an electron and a charge when a three-phase interface is formed with a solid polymer electrolyte (ionomer), and also functions as a promoter of the second catalyst material. The polyacid functions as a promoter of the second catalyst material, thereby reducing activation polarization and improving the activity of the second catalyst material. Thus, by using, as a catalyst layer, a catalyst material in which a polyacid is bound to a second catalyst material, the power generation efficiency of a fuel cell can be increased. Further, since the polyacid is bound to the second catalyst material through a thiol bond, high power generation efficiency can be maintained.

Therefore, by binding the polyacid to the second catalyst material, the improvement in the output as a fuel cell and the durability of a fuel cell can be achieved.

(Second Catalyst Material)

Any materials can be used as the second catalyst material as long as the material is bound to the sulfur atom of the thiol group of the polyacid as the first catalyst material and functions as a catalyst. As such a material, a structural member formed of platinum is preferred. Here, examples of the structural member formed of platinum include a structural member of platinum, a structural member formed of an alloy of platinum and other metal(s), a structural member which has a stack structure having a plurality of layers and in which at least a part of the uppermost one of the layers contains platinum, and the like. Examples of other metals in the structural member formed of an alloy of platinum and other metal(s) include gold, silver, palladium, iridium, rhodium, ruthenium, iron, cobalt, nickel, chromium, tungsten, manganese, vanadium, rhenium, cobalt, lithium, lanthanum, strontium, yttrium, and osmium. Further, a structure in which a part of a structural member of platinum is covered with gold can also be used.

The shape of the catalyst formed of the first catalyst material and the second catalyst material is not particularly limited, and may be in the form of, for example, a sphere (fine particle), a dendrite, and a wire.

The term “dendrite shape” herein employed refers to a structure in which a number of flake (thin piece)-shaped structures each formed by an assembly of catalyst particles are gathered together while having a branch point thereof. It is preferable that one flake-shaped structure has a length in a widthwise direction of 5 nm or more and 200 nm or less. Incidentally, the term “widthwise direction” herein employed refers to the smallest in-plane dimension of one flake. With respect to the assembly of dendrite-shaped platinum nanoparticles, a technology disclosed in, for example, Japanese Patent Application Laid-Open No. 2006-049278 can be applied to the present invention.

(Bond Between First Catalyst Material and Second Catalyst Material)

The sulfur atom of the thiol group of the polyacid as the first catalyst material and the second catalyst material are bound to each other by a thiol bond as represented by the following chemical formula:

D-S-E (2)

wherein D represents a portion other than the thiol group of the polyacid, S represents a sulfur atom of the thiol group of the polyacid, and E represents an atom of the second catalyst material.

The above-mentioned thiol bond between the first catalyst material and the second catalyst material refers to bond between the sulfur atom and a specific material such as platinum, which is caused by release of a hydrogen atom from the thiol group.

Further, it is preferable for the catalyst layer to contain a solid polymer electrolyte in addition to the first catalyst material and the second catalyst material.

The catalyst layer can be produced by mixing the first catalyst material and the second catalyst material to form a mixture to thereby bind the first catalyst material and the second catalyst material through a thiol bond.

Further, a membrane electrode assembly can basically generate power by virtue of the presence of a polymer electrolyte membrane capable of transporting cations to an anode side, and a catalyst electrode capable of taking out electrons generated in an anode and a cathode. Therefore, the carrier does not necessarily need to be provided. However, a carrier material capable of allowing electron movement may be further provided in a catalyst layer mainly for the purpose of reducing the amount of platinum used.

Examples of the carrier material include a carrier which carries the second catalyst material. Carbon can be mainly used for the carrier, but a material that can be used therefor is not limited to carbon as long as it is an electron conducting material. Examples of a carrier formed of carbon include: carbon black such as furnace black, channel black, and acetylene black; activated carbon; graphite; fullerene; a carbon nanotube; and a carbon fiber, which may be used singularly or in combination.

(Polymer Electrolyte Membrane)

The polymer electrolyte membrane as a constituent element of the membrane electrode assembly of the present invention has a proton conducting group and has a function of transferring protons generated on the anode side to the cathode side. To be specific, examples of the group having such a proton conducting group include a sulfonic group, a sulfinic group, a carboxyl group, a phosphonic group, a phosphinic group, a phosphate group, and a hydroxyl group. Further, examples of the polymer electrolyte membrane preferably include organic polymers containing those proton conducting groups, and for example, a perfluorocarbon sulfonate resin, a polystyrene sulfonate resin, a sulfonated polyamide imide resin, a sulfonated polysulfonic resin, a sulfonated polyether imide semi-permeable membrane, a perfluorophosphonic acid resin, and a perfluorosulfonic acid resin are mentioned.

Next, a method of producing the membrane electrode assembly of the present invention will be described.

The method of producing the membrane electrode assembly of the present invention is a method of producing a membrane electrode assembly including at least a polymer electrolyte membrane and a catalyst layer including a first catalyst material and a second catalyst material. The method of producing the membrane electrode assembly of the present invention includes: mixing a first catalyst material including a polyacid having a thiol group and a second catalyst material which is different from the first catalyst material to form a mixture thereby binding the first catalyst material and the second catalyst material through a thiol bond; and disposing the mixture on a surface of the polymer electrolyte membrane.

It is preferable for the mixture to contain a solid polymer electrolyte.

Methods of bringing the catalyst material containing the first catalyst material and the second catalyst material into contact with the solid polymer electrolyte are roughly classified into the following two methods. The first method includes: mixing beforehand the catalyst material containing the first catalyst material and the second catalyst material with the solid polymer electrolyte; and applying the mixture to a surface of the polymer electrolyte membrane. The second method includes: coating the second catalyst material with the solid polymer electrolyte; then mixing the resultant with the first catalyst material; and applying the mixture to a surface of the polymer electrolyte membrane.

In the both methods, in the present invention, the first catalyst material and the second catalyst material are mixed, thereby binding the first catalyst material and the second catalyst material via the thiol group of the polyacid which constitutes the first catalyst material. There is no limitation on the mixing conditions of the first catalyst material and the second catalyst material as long as the first catalyst material and the second catalyst material are brought into contact with each other without decomposition thereof.

Hereinafter, the fuel cell of the present invention will be described.

The fuel cell of the present invention has the above-mentioned membrane electrode assembly.

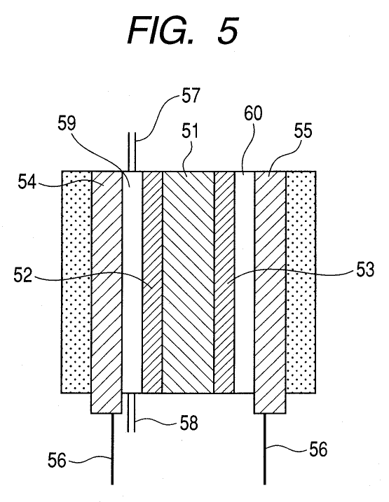

FIG. 5 illustrates an example of a fuel cell unit constituting the above fuel cell of the present invention. The fuel cell unit shown in FIG. 5 is constituted of a solid polymer electrolyte membrane 51, an anode catalyst layer 52, a cathode catalyst layer 53, an anode side current collector 54, a cathode side current collector 55, external output terminals 56, a fuel introduction line 57, a fuel discharge line 58, an anode side fuel diffusion layer 59, and a cathode side fuel diffusion layer 60. A chemical reaction occurs at a three-phase interface on the surface of the catalyst layer to generate power.

As a structure of the fuel cell, a structure having a single cell unit mentioned above may be employed, but a structure in which a plurality of such cell units are stacked may preferably be employed. Such a structure can increase the generated voltage value and current value.

For the diffusion layer, it is preferable to use a conductive member which has a high porosity and has been subjected to water-repellent treatment, and for example, carbon fiber fabric or carbon paper can be suitably used.

Further, a microporous layer which is formed of carbon and has a pore diameter smaller than that of the diffusion layer may be inserted between the diffusion layer and the catalyst layer.

The fuel cell of the present invention may have a structure in which a single fuel cell unit mentioned above is provided or may have a structure in which a plurality of such fuel cell units are stacked.

Incidentally, the fuel used for the fuel cell of the present invention is not particularly limited as long as it generates electrons and cations by the action of a catalyst electrode at an anode side and a solid polymer electrolyte membrane. Examples of such a fuel include hydrogen, reformed hydrogen, methanol, and dimethyl ether. At the cathode side, any fuel, such as air or oxygen, which receives cations and incorporates electrons can be used. In general, using hydrogen or methanol at the anode side and using air at the cathode side are suitable from the viewpoint of the reaction efficiency and practical use.

### EXAMPLES

Hereinafter, the present invention will be specifically described with reference to Examples.

### Example 1

In this example, there is described an example of producing a membrane electrode assembly by simultaneously mixing a polyacid as a first catalyst material, a structural member (platinum fine particles) formed of platinum in the form of fine particles as a second catalyst material, and Nafion (tradename; manufactured by DuPont) as a solid polymer electrolyte to thereby form a catalyst sheet, and then transferring the catalyst layer to a surface of a Nafion film.

First, as the first catalyst material, a polyacid having a thiol group represented by (CH₃)₂NH₂)5H[(α₂-P₂W₁₇O₆₁{(HS(CH₂)₃Si)₂O}].6H₂O was synthesized. The synthesis method is based on the description in Chem. Eur. J., No. 10 (2004), page 5517, for example.

The polyacid was dissolved in pure water, thereby preparing 0.5 mmol/L of aqueous solution. Subsequently, 1.0 g of platinum fine particles having an average crystallite diameter of 5 nm was put in a crucible. To the crucible, 0.4 mL of the aqueous polyacid solution, 1.5 mL of a 5% Nafion solution, and 0.2 mL of isopropyl alcohol were sequentially added using a micropipet. Then, the crucible was subjected to ultrasonic mixing for 5 minutes. Further, a stirrer was put in the crucible, and then the crucible was stirred at 200 rpm using a magnetic stirrer. Thus, the polyacid was bound to the surfaces of the platinum fine particles.

The platinum fine particle-polyacid mixed solution thus produced was applied to the surface of a polytetrafluoroethylene sheet by a doctor blade method, thereby forming a catalyst layer containing a solid polymer electrolyte. Thereafter, the catalyst layer was transferred to the surface of a Nafion film using hot pressing, thereby producing a membrane electrode assembly.

The membrane electrode assembly was incorporated as illustrated in FIG. 5, thereby obtaining a fuel cell unit.

Hydrogen was injected into the anode side of the fuel cell unit and air was injected into the cathode side of the fuel cell unit as a fuel, and then measurement was performed.

As Comparative Example 1, a membrane electrode assembly was produced by following the same procedure as in Example 1 with the exception that a catalyst layer (catalyst layer formed of platinum fine particles and Nafion) having no polyacid added thereto was used instead of the catalyst layer used in Example 1, and a fuel cell unit was produced using the membrane electrode assembly.

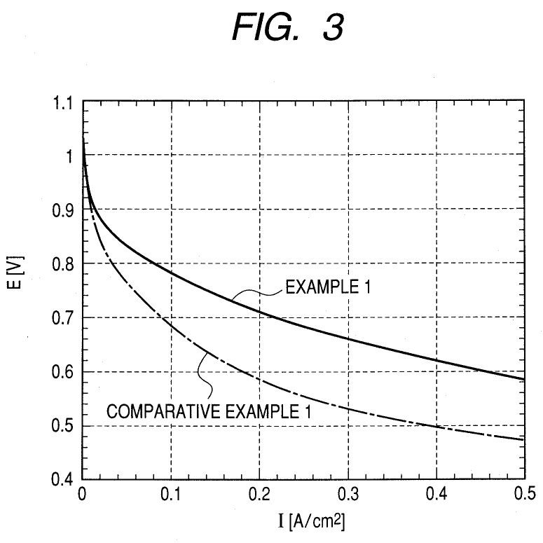

Using the obtained cell units, the current-potential characteristics of the single fuel cell unit were evaluated. The unit temperature was adjusted to 40° C. and 50% humidified hydrogen was used at the anode side and air similarly humidified was used at the cathode side. The hydrogen and the air were supplied at flow rates of 500 mL/min and 2,000 mL/min, respectively, and the produced single cell unit was operated. The measurement results are illustrated in FIG. 3. The potential difference at 400 mA/cm² between the cell unit produced in Example 1 and the cell unit produced in Comparative Example 1 was 120 mV and the performance of the cell unit of Example 1 greatly exceeded the performance of the cell unit of Comparative Example 1. Further, even when the same membrane electrode assemblies were repeatedly used, the performance of the cell unit of Example 1 was not degraded to the performance of the cell unit of Comparative Example 1. Therefore, it is considered that by fixing the polyacid to the platinum fine particles, the membrane electrode assembly of this example can successfully maintain the effect of promoting the oxygen reduction reaction and the moisturizing effect by the polyacid over a long period of time, thereby improving the power generation efficiency.

### Example 2

Example 2 refers to an example in which a structural member formed of platinum in the form of a dendrite was produced as the second catalyst material, and the polyacid which was the first catalyst material was bound to the surface of the structural member formed of the platinum, thereby producing a modified electrode.

First, a structural member formed of a dendrite-shaped platinum was produced. In the production, a polytetrafluoroethylene sheet as a substrate was placed in a sputtering chamber, and the pressure inside the chamber was evacuated to 1.0×10⁻⁴ Pa, and then Ar and O₂ were introduced into the chamber at 2.5 sccm and at 20.0 sccm, respectively; and the total pressure was adjusted to 6.0 Pa using an orifice. Reactive sputtering was performed at an RF input power of 4.0 W/cm², thereby forming a structural member of platinum oxide having a dendritic shape on the sheet in a film thickness of about 100 nm.

Next, the substrate having the platinum oxide structural member formed on the surface thereof was exposed to H₂/He (H₂: 2%) at 10 kPa for 10 minutes, thereby reducing the platinum oxide.

Thereafter, a Nafion solution whose concentration was adjusted using isopropyl alcohol was added dropwise to the catalyst layer having the dendritic shape formed on the sheet, followed by drying. The catalyst carrying sheet which was cut in the shape of a 5 mm diameter circle was transferred to a 5 mm diameter disc electrode by using hot pressing, thereby obtaining a modified electrode. Then, the modified electrode was immersed for about 10 seconds in a 1.0 mmol/L aqueous polyacid solution prepared in the same manner as in Example 1, washed with water, and dried.

In order to analyze the activity of the modified electrode of this example, measurement was performed using a rotating electrode process at a rotation frequency of 1,600 rpm while sweeping an electric potential. The measurement was performed by placing the modified electrode as a working electrode in a 0.1 mol/L supporting salt. In this measurement, a silver/silver chloride electrode was used as a reference electrode and a platinum wire was used as a counter electrode.

As Comparative Example 2, a modified electrode was produced by following the same procedure as in Example 2 with the exception that the modified electrode was not immersed in the polyacid solution, and measurement was performed using the thus produced modified electrode.

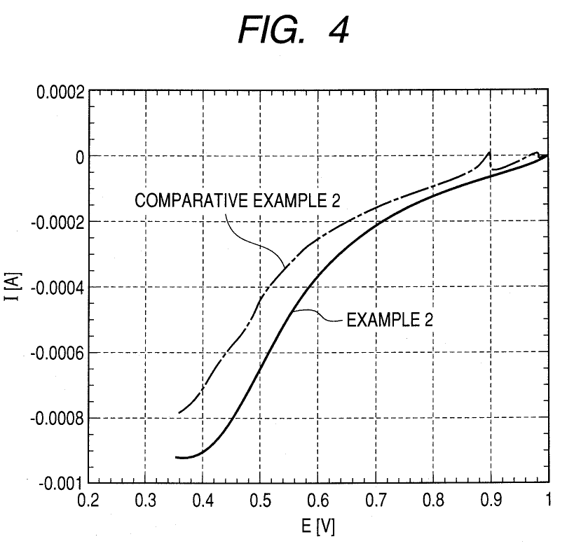

The measurement results of Example 2 and Comparative Example 2 are illustrated in FIG. 4. The measurement results show that the modified electrode produced in Example 2 was improved in oxygen reducing ability compared with the modified electrode of Comparative Example 2. Thus, it was confirmed that the activation was improved by fixing the polyacid. Here, the electric potential at which an oxygen reducing current starts to flow reflects the reaction catalyst activity of the modified electrode, and means that an electrode through which the oxygen reducing current flows at a higher positive potential has a high activity. Further, even when the same modified electrodes were repeatedly used, the performance of the modified electrode of Example 2 was not degraded to the performance level of the modified electrode of Comparative Example 2. Therefore, it is considered that by fixing the polyacid to the structural member formed of the dendrite-shaped platinum, the promotion of the oxygen reduction reaction by the polyacid was successfully maintained over a long period of time.

### Example 3

In this example, a structural member formed of a dendrite-shaped platinum as a second catalyst material was coated with a Nafion solution, and then, the polyacid as a first catalyst material was bound thereto, thereby producing a membrane electrode assembly.

First, a structural member formed of a dendrite-shaped platinum was produced. In the production, a polytetrafluoroethylene sheet as a substrate was placed in a sputtering chamber, and the pressure inside the chamber was evacuated to 1.0×10⁻⁴ Pa, and then Ar and O₂ were introduced into the chamber at 2.5 sccm and at 20.0 sccm, respectively; and the total pressure was adjusted to 6.0 Pa using an orifice. Reactive sputtering was performed at an RF input power of 4.0 W/cm², thereby forming platinum oxide having a dendritic shape on the sheet in a film thickness of about 2.0 μm.

The substrate having the platinum oxide film formed thereon was exposed to H₂/He (H₂: 2%) at 10 kPa for 10 minutes, whereby the platinum oxide was easily reduced. Thereafter, a Nafion solution whose concentration was adjusted using isopropyl alcohol was added dropwise to the catalyst, followed by drying. Thereafter, the resultant was immersed for about 10 seconds in a 0.5 mmol/L aqueous polyacid solution prepared in the same manner as in Example 1, washed with water, and dried. The polyacid-containing catalyst layer thus produced was transferred to a Nafion film using hot pressing, thereby producing a membrane electrode assembly.

Using the membrane electrode assembly, a cell unit in which hydrogen was injected into the anode side and air was injected into the cathode side as fuel was produced by following the same procedure as in Example 1.

As Comparative Example 3, a membrane electrode assembly was produced by following the same procedure as in Example 3 with the exception that a catalyst layer (catalyst layer formed of the structural member formed of the dendrite-shaped platinum and Nafion) having no polyacid added thereto was used instead of the catalyst layer used in Example 3, and a fuel cell unit was produced using the membrane electrode assembly.

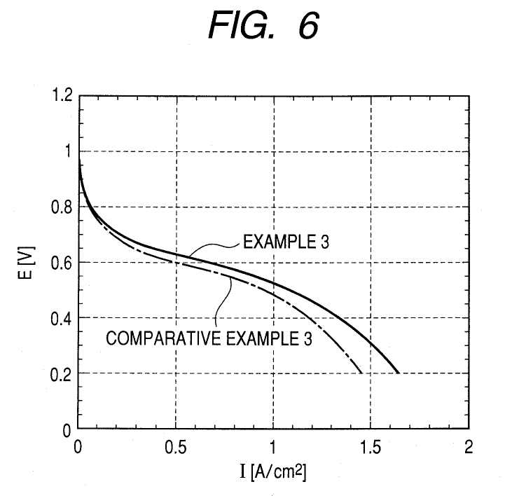

Using the obtained cell units, the current-potential characteristics of the single fuel cell unit were evaluated. The unit temperature was adjusted to 40° C. and 40% humidified hydrogen was used at the anode side and air similarly humidified was used at the cathode side. The hydrogen and the air were supplied at flow rates of 500 mL/min and 2,000 mL/min, respectively, and the produced single cell unit was operated. The measurement results are illustrated in FIG. 6. The potential difference at 400 mA/cm² between the cell unit produced in Example 3 and the cell unit produced in Comparative Example 3 was 50 mV and the performance of the cell unit of Example 3 greatly exceeded the performance of the cell unit of Comparative Example 3. Further, even when the same membrane electrode assemblies were repeatedly used, the performance of the cell unit of Example 3 was not degraded to the performance of the cell unit of Comparative Example 3. Therefore, it is considered that by fixing the polyacid to the structural member formed of the dendrite-shaped platinum and using the resultant as a catalyst, the membrane electrode assembly of Example 1 can successfully maintain the effect of promoting the oxygen reduction reaction and the moisturizing effect by the polyacid over a long period of time, thereby improving the power generation efficiency.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-120002, filed Apr. 27, 2007, which is hereby incorporated by reference herein in its entirety.

What is claimed is:

1. A catalyst layer comprising:
a first catalyst material; and
a second catalyst material which is different from the first catalyst material,
wherein the first catalyst material comprises a polyacid having a thiol group, and wherein the first catalyst material and the second catalyst material are bound to each other through a thiol bond.

2. The catalyst layer according to claim 1, wherein the second catalyst material comprises platinum.

3. The catalyst layer according to claim 1, wherein the polyacid has an organosilyl group.

4. A membrane electrode assembly comprising:
two catalyst layers; and
a polymer electrolyte membrane,
wherein at least one of the catalyst layers comprises the catalyst layer set forth in claim 1.

5. A fuel cell comprising the membrane electrode assembly set forth in claim 4.

6. A method of producing a catalyst layer which comprises mixing a first catalyst material comprising a polyacid having a thiol group and a second catalyst material which is different from the first catalyst material to form a mixture, thereby binding the first catalyst material and the second catalyst material through a thiol bond.

7. The method of producing a catalyst layer according to claim 6, wherein the mixture of the first catalyst material and the second catalyst material contains a solid polymer electrolyte.

8. A method of producing a membrane electrode assembly which comprises disposing the catalyst layer produced by the method set forth in claim 7 on a surface of a solid polymer electrolyte membrane.
